(19) United States
(12) Patent Application Publication
(10) Pub. No.: US 2026/0187666 A1
(43) Pub. Date: Jul. 2, 2026

(54) DATA ANALYSIS SYSTEM FOR REAL ESTATE DEVELOPMENT

(71) Applicant: RCKRBX, Inc., Alexandria, VA (US)

(72) Inventors: Michael BRODER, Rockville, MD (US); James MOORE, Alexandria, VA (US); Kevin HUDAK, Washington, DC (US); William DRYFOOS, Vienna, VA (US)

(21) Appl. No.: 19/127,220

(22) PCT Filed: Nov. 6, 2023
(86) PCT No.: PCT/US2023/036879

§ 371 Date: May 5, 2025

Related U.S. Application Data
(60) Provisional application No. 63/422,634, filed on Nov. 4, 2022.

(51) Int. Cl. G06Q 30/0203; G06Q 50/16

(52) U.S. Cl. CPC G06Q 30/0203; G06Q 50/165

(57) ABSTRACT

An approach for data mining relating to real estate assets is disclosed. The approach comprises generating a questionnaire for determining preference information relating to a real estate development project. The approach further comprises determining a plurality of candidate users according to a candidate criteria. The approach further comprises presenting, via a graphical user interface, the questionnaire to the plurality of candidate users to collect the preference information. The approach also comprises analyzing the preference information with respect to a project criteria for the real estate development project. The approach further comprises outputting project data for the real estate development project based on the analysis, wherein the project date includes architectural information.

### RELATED APPLICATIONS

This application claims priority to International Application No. PCT/US2023/036879, titled “Data Analysis System for Real Estate Development,” filed Nov. 6, 2023, which claims the benefit of U.S. Provisional Ser. No. 63/422,634 , titled “Data Analysis System for Real Estate Development,” filed Nov. 4, 2022, the contents of which are incorporated by reference herein in its entirety.

### BACKGROUND

Real estate development has traditionally been driven by the experience and intuition of the developer. Because of the tremendous investment and expense required to develop a project, there are significant risks, particularly if the end consumers'preferences are unknown or merely speculative. Given the dynamic nature of the economy and consumer behavior, acquiring information about consumer preferences poses an enormous challenge. To add to the complexity, there are different types of consumers; and their preferences vary with time. Also, the residential consumers'preferences may vary greatly based on lifestyles. On the commercial side, preferences will be dictated by the type and size of the business. Moreover, development projects that require consideration of preferences of both residential consumers and commercial consumers are even more complex. Despite the advances in data processing technologies, such technologies have not been integrated or applied well in the real estate industry, thereby introducing unnecessary financial risks for both the developer and the consumer. Moreover, conventional approaches have not keep pace with technological advancements in machine learning.

### SOME EXAMPLE EMBODIMENTS

Therefore, there is a need for an approach that applies data mining and analysis to support real estate development.

According to one embodiment, a method comprises generating a questionnaire for determining preference information relating to a real estate development project. The method further comprises determining a plurality of candidate users according to a candidate criteria. The method further comprises presenting, via a graphical user interface, the questionnaire to the plurality of candidate users to collect the preference information. The method also comprises analyzing the preference information with respect to a project criteria for the real estate development project. The method further comprises outputting project data for the real estate development project based on the analysis, wherein the project date includes architectural information.

According to another embodiment, a system comprises a memory configured to store computer-executable instructions; and one or more processors configured to execute the instructions to generate a questionnaire for determining preference information relating to a real estate development project. The one or more processors are further configured to execute the instructions to determine a plurality of candidate users according to a candidate criteria; and to present, via a graphical user interface, the questionnaire to the plurality of candidate users to collect the preference information. The one or more processors are further configured to execute the instructions to analyze the preference information with respect to a project criteria for the real estate development project; and to output project data for the real estate development project based on the analysis, wherein the project date includes architectural information.

According to another embodiment, an apparatus comprises at least one processor, and at least one memory including computer program code for one or more computer programs, the at least one memory and the computer program code configured to, with the at least one processor, cause, at least in part, the apparatus to generate a questionnaire for determining preference information relating to a real estate development project. The apparatus is also caused to determine a plurality of candidate users according to a candidate criteria. The apparatus is also caused to present, via a graphical user interface, the questionnaire to the plurality of candidate users to collect the preference information. The apparatus is also caused to analyze the preference information with respect to a project criteria for the real estate development project. The apparatus is further caused to output project data for the real estate development project based on the analysis, wherein the project date includes architectural information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a data mining platform, according to one embodiment;

FIG. 2 is a diagram of the components of the data mining platform of FIG. 1, according to one embodiment;

FIG. 3 is a diagram of the data mining platform of FIG. 1 interacting with various data sources, according to one embodiment;

FIGS. 4A-4D are flowcharts of processes for maximizing real estate assets by the data mining platform of FIG. 1, according to various embodiments;

FIG. 5 is a diagram of a graphical user interface (GUI) presented by the data mining platform of FIG. 1 for developer scenario analysis, according to one embodiment;

FIG. 6 is a diagram of a GUI presented by the data mining platform of FIG. 1 for specifying a developer project scenario analysis, according to one embodiment;

FIG. 7 is a diagram of a GUI presented by the data mining platform of FIG. 1 for displaying location of survey respondents, according to one embodiment;

FIG. 8 is a diagram of a GUI presented by the data mining platform of FIG. 1 for specifying asset details relating to a developer scenario analysis, according to one embodiment;

FIG. 9 is a diagram of a GUI presented by the data mining platform of FIG. 1 for providing a unit mix and demand summary associated with a developer scenario analysis, according to one embodiment;

FIG. 10 is a diagram of a GUI presented by the data mining platform of FIG. 1 for providing information relating to physical/built-in amenities placement with an asset, according to one embodiment;

FIG. 11 is a diagram of a GUI presented by the data mining platform of FIG. 1 for providing information relating to locational attributes, according to one embodiment;

FIG. 12 is a diagram of a GUI presented by the data mining platform of FIG. 1 for specifying information relating to unit mix and details, according to one embodiment;

FIG. 13 is a diagram of a GUI presented by the data mining platform of FIG. 1 for providing information relating to an optimized asset, according to one embodiment;

FIG. 14 is a diagram of a neural network that can be implemented by the data mining platform of FIG. 1, according to one embodiment;

FIG. 15 is a diagram of hardware that can be used to implement various example embodiments;

FIG. 16 is a diagram of a chip set that can be used to implement various example embodiments; and

FIG. 17 is a diagram of a mobile terminal (e.g., handset) that can be used to implement various example embodiments.

### DESCRIPTION OF SOME EMBODIMENTS

Examples of a method, apparatus, and computer program for data mining relating to real estate assets are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

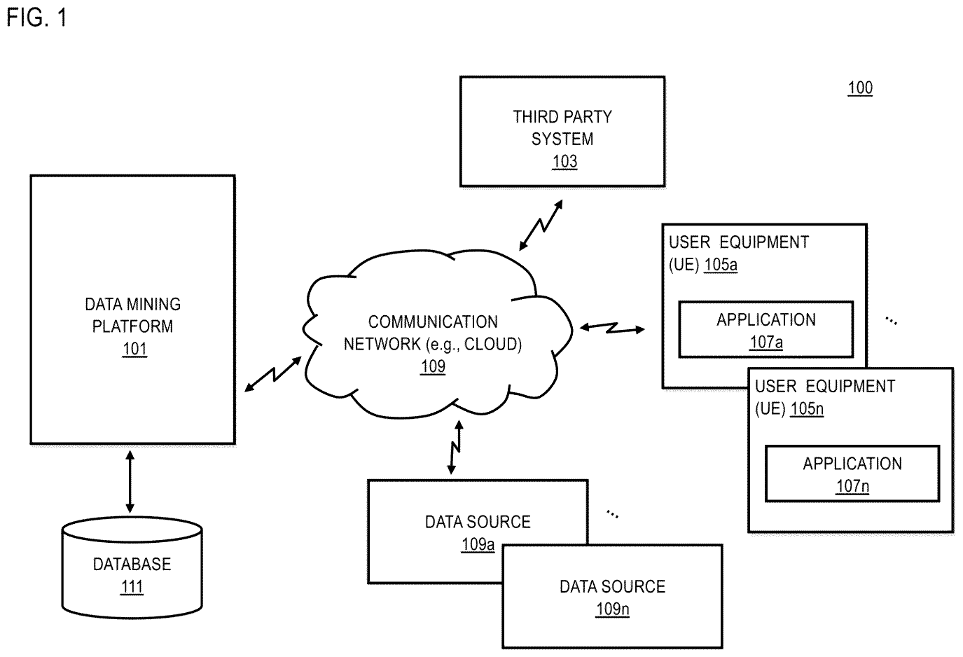

FIG. 1 is a diagram of a data mining platform, according to one embodiment. In the hyper-commoditized real estate market, simply intuiting what audiences want is no longer sufficient. Those involved with any development project must know what matters to whom to earn outsized returns in today's increasingly specialized, “renter-driven” real estate economy. For years, the real estate industry has made multi-million-dollar decisions based largely on gut intuition, anecdotal evidence and incomplete, often backward-looking, market data—making it difficult to draw clear hypotheses, quantify business cases and mitigate risk. While current industry practice provides a picture of what happened, it offers no real understanding of why it happened, what the future holds or how to capitalize on it. With impactful external forces (e.g., such as a global pandemic), changes that have been gradually developing over time are suddenly fully manifest. Traditional market metrics, trends and cycles have been sped up, slowed down and upended. Rising material costs and delays are putting unique pressures on new projects. The amenities arms race, the industry's cold war fueled by hyper-commoditization, is now at a virtual standoff and will require fresh evaluation.

By way of example, the technical challenges include but are not limited to providing actionable intelligence that comprehensively addresses the problems and issues described above.

To address the noted drawbacks of conventional systems and approaches to data modeling for real estate development projects, a system 100 of FIG. 1 includes a data mining platform 101 that efficiently utilize data to maximize the performance of assets, such as commercial real estate. The performance can be across the entire ownership lifecycle. A key aspect for efficient data processing is to produce meaningful data through the use of polling or surveying of relevant respondents; as such, technological improvements can be gained by minimizing the storage of redundant or marginally useful data as well as developing a machine learning training model that can increase accuracy of predictions relating to performance of development projects. Among other functions and features, the platform 101 can acquire consumer preference information (e.g., with respect to potential consumers) for consideration in the planning and execution of real estate development projects. This, in essence, puts the voice of the consumer (e.g., tenant) “at the table” across key investment, development, marketing, leasing, and management decision points. By way of example, the platform 101 provides actionable intelligence around renter preferences, priorities, attitudes, and viewpoints that drive decision-making and matter most to people when selecting their next “live-space” combined with the predictive foresight to understand how these factors will impact asset performance and value over time, to what extent and why.

The advantage of the platform 101 over conventional systems stems from determining real-time human insights and their linkage to familiar real estate datasets, market metrics and other secondary sources to establish leading indicators of asset performance. Leveraging proprietary data science, machine learning and predictive analytics, our industry leading insight models cull millions of primary audience insights (e.g., polling data) and thousands of geographic, demographic and psychographic variables to accurately predict renter behavior, their decision-making and drivers of demand, loyalty and premiums with greater precision, depth and breadth than conventional systems.

The platform 101 can identify target audiences, such that a determination can be made as to what matters most to them and how such factors will impact asset performance over time. For example, the platform 101 can identify, size, and prioritize the prospective populations most likely to consider and choose a development project (versus all qualified renters in market) based on what the consumers are looking for in their next live-space; the preferences, lifestyle interests and lifestage wants and needs which influence their decision-making; the location, building and unit attributes they desire/value most; and to what extent all of these factors impact demand intensity, lease likelihoods and rent premiums.

Additionally, the platform 101 can collect preference information to understand a renter preferences and priorities. In this manner, the developer can have knowledge of what to build for whom, where and at what cost or how to maximize demand, pace and premiums to earn greater returns—before an asset is acquired. The platform 101 can efficiently (e.g., in real-time or near real-time) extract the preferences, priorities and perceptions of high-propensity renter populations and use those insights to evaluate investment theses; predict performance of development and/or repositioning scenarios against actual market appetite; align asset programming to target audience demand and premium drivers; and forecast achievable returns.

With respect to project performance, the platform 101 has the capability to predict such performance with high accuracy. Consequently, the developer can more accurately predict investment opportunities with outsized performance potential and quantifiably evaluate underwriting as well as other development assumptions for a new project. The platform 101 can pressure-test project feasibility, identify the ideal risk-return balance down to the unit and audience levels, and optimize development path to maximize returns by validating market demand, opportunity depth and timing, location favorability, asset type and size, unit mix (including configurations, finishes and features), amenity programming, and rent thresholds as well as how these factors will impact asset performance and value over time.

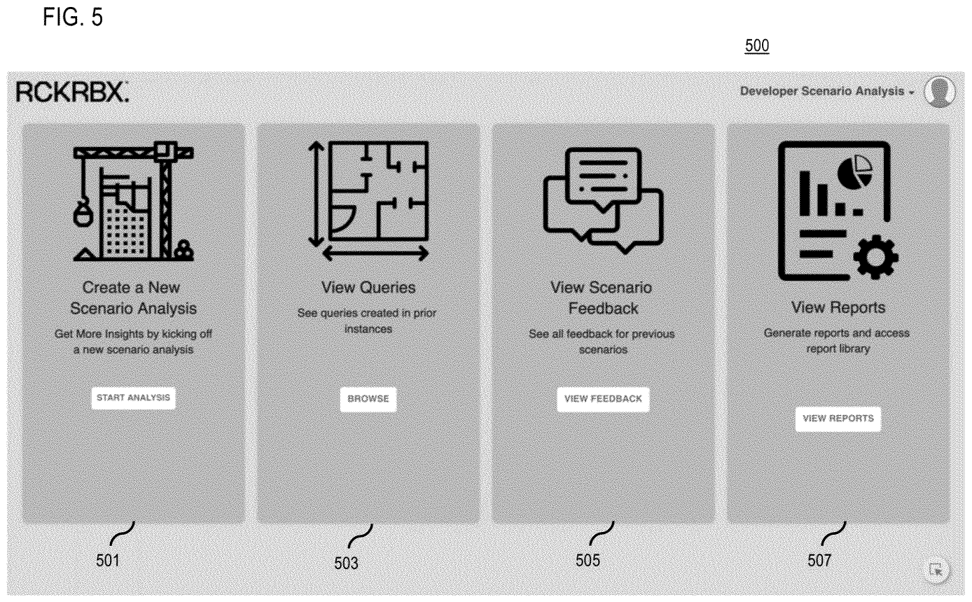

As shown in FIG. 1, the system 100 also comprises user equipment (UE) 105a-105n (collectively referred to as UE 105) that may include or be associated with applications 107a-107n (collectively referred to as applications 107). In one embodiment, the UE 105 has connectivity to the data mining platform 101 via the communication network 109. Under certain scenarios, the data mining platform 101 performs one or more functions associated with data analysis in conjunction with the UEs 105a-105n. By way of example, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 105 can support any type of interface to the user (such as “wearable” circuitry, etc.). In one embodiment, the UE 105 may include Global Positioning System (GPS) receivers to obtain geographic coordinates from satellites (not shown) for determining current location and time associated with the UE 105; such GPS information can be utilized to geo-tag images captured by UE sensors (not shown). The UE 105 is capable of supporting a graphical user interface (GUI) that provides the GUI of FIGS. 5-13.

The data mining platform 101 operates in conjunction with one or more applications resident on an UE 105. By way of example, the applications 107 may be any type of application that is executable at UE 105, such as content provisioning services, camera/imaging application, media player applications, social networking applications, calendar applications, and the like. In one embodiment, the applications 107 may assist in conveying sensor information via the communication network 109. In another embodiment, one of the applications 107 at the UE 105 may act as a client for the data mining platform 101 and perform one or more functions associated with the functions of the platform 113 by interacting with the platform 113 over the communication network 109.

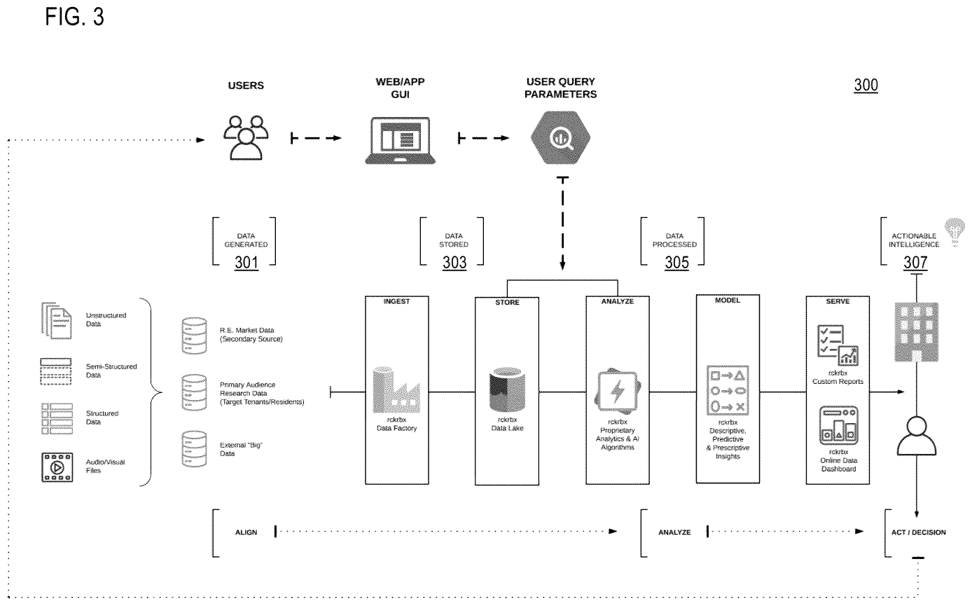

One or more data sources 109a-109n are accessible via the network 109 by the platform 101. The data sources 109a-109n can include any content relevant to making financial decisions relating to securities, such as market data (e.g., historical or real-time market information), news, financial holdings, alternative data (as shown in FIG. 3). The retrieved data can reside within database 111 of the data mining platform 101. It is contemplated that database 111 can be implemented as a cloud storage system. According to one embodiment, the data is made up of primary audience insights combined with secondary data including hyperlocal, web-based, economic and real estate market datasets. With the platform 101, users can proactively adapt projects to renter preferences and modern needs, and drive greater demand, loyalty, premiums, advocacy, and returns.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the data mining platform 101 may be a platform with multiple interconnected components. The Data mining platform 101 may include multiple servers, intelligent networking devices, computing devices, components and corresponding software for providing real-time data analysis. In addition, it is noted that the data mining platform 101 may be integrated or separated from services platform. Also, certain functionalities of the platform 101 may reside within the UE 105 (e.g., as part of the applications 107).

Moreover, the platform 101 can interface with various services systems (not shown), such as notification services, content (e.g., audio, video, images, etc.) provisioning services, application services, storage services, contextual information determination services, social networking services, location-based services, information-based services, etc.

By way of example, UE 105, the data mining platform 101, the third party system 103 with each other and other components of the communication network 109 using well known, new or still developing protocols (e.g., IoT standards and protocols). In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

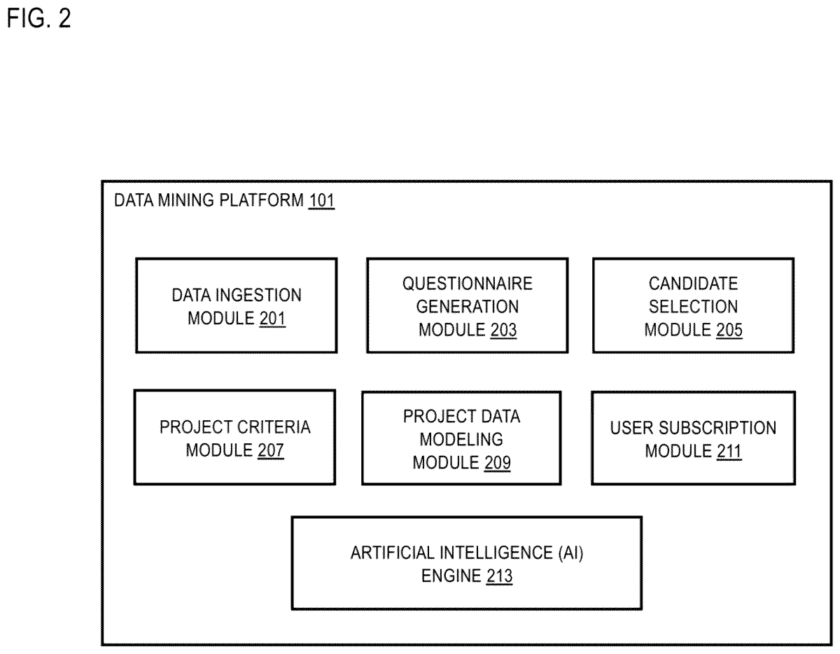

FIG. 2 is a diagram of the components of the data mining platform of FIG. 1, according to one embodiment. By way of example, the platform 101 includes one or more components for analyzing data to model and assess performance of development projects. It is contemplated that the functions of these components may be combined in one or more components or performed by other components of equivalent functionality. In this embodiment, the data mining platform 101 includes the following modules: a data ingestion module 201, a questionnaire generation module 203, a candidate selection module 205, a project criteria module 207, a project data modeling module 209, a user subscription module 211, and an artificial intelligence engine 213.

The data ingestion module 201 can access various different data sources 109a-109n to ingest the information for processing. Market or “big” data is mined from secondary sources for broad product or population trends, comparative benchmarking, etc. and suggests likelihoods based on the assumption that “what has been” will “continue to be”. However, things change. The real value of market data is the history and context for decision-making it provides when combined with primary audience insights.

The questionnaire generation module 203 creates surveys for obtaining consumer preference information, and operates with the candidate selection module 205 to identify the appropriate audience for such surveys. Primary audience data (e.g., polling insights) are derived from specific populations and their preferences, attitudes, and behaviors. The platform 101 provides a quantifiable look into what is likely to happen based on what renters say about particular desires, expectations and intentions. Primary audience insights are the purest form of actionable intelligence—particularly when used to predict market movement, extract critical insights from big data, and properly account for the various factors impacting how an asset will perform (i.e., demand, loyalty, and premiums) over time and why.

Additionally, the questionnaire generation module 203 interacts with the project criteria module 207 to generate questions that reflect or takes into consideration any desired project criteria.

The project data modeling module 209 can process all the data to produce analytics that focus on understanding “the why” at the intersection of audience and market data to inform “the how and what”. The goodness from each data set complements the other and, together, provide a far more rich, true and complete understanding of “what actually is” and “what ought to be.”

The user subscription module 211 administers user accounts for the services of the platform 101. In one embodiment, the user subscription module 211 provides a Software As a Service (SaaS) model.

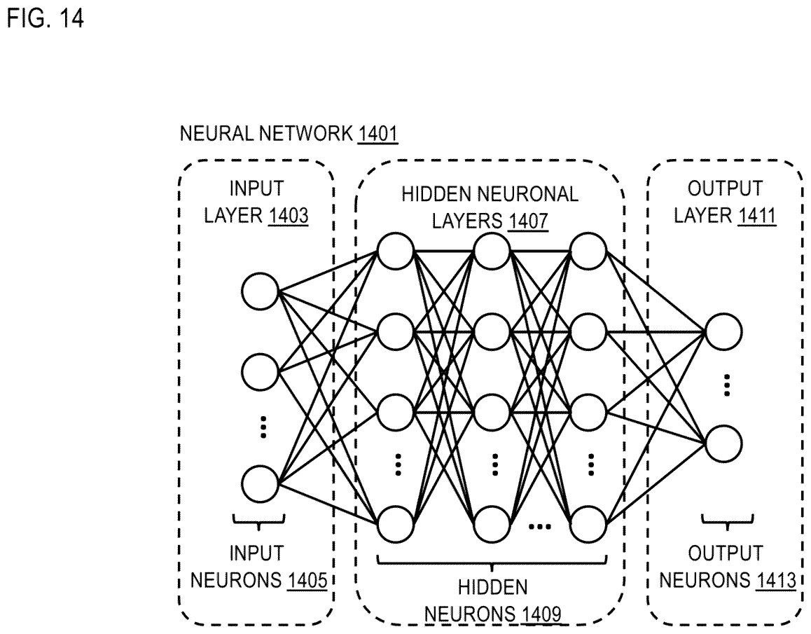

The artificial intelligence (AI) engine 213 interacts with one or more of the various modules 201-211 to support the functions of the platform 101. By way of example, the AI engine 213 can execute the neural network of FIG. 14. More specifically, the AI engine 213 can be trained using survey results for a variety of audiences to generate more clear and accurate questions. In turn, this will improve the accuracy of the predictions and modeling of the real estate project performance.

In one embodiment, a machine learning model can be trained using a training data set comprising examples of preference information (extracted from responses from questionnaires/surveys) that have been labeled with corresponding value metrics. This labeled data is used as the ground truth data for training. Multiple different loss functions and/or supervision schemes can be used alternatively or together to train the machine learning model to predict the value metric for preference information. One example scheme is based on supervised learning. For example, in supervised learning, the AI engine 213 can incorporate a learning model (e.g., a logistic regression model, Random Forest model, and/or any equivalent model) to train the machine learning model to make predictions (e.g., predictions of the value metric) from input features. During training, the AI engine 213 can feed feature sets from a training data set into the machine learning model to compute a predicted value metric using an initial set of model parameters. The AI engine 213 then compares the predicted matching probability and value metric to ground truth data in the training data set for each training example used for training. The AI engine 213 then computes accuracy of the predictions (e.g., via a loss function) for the initial set of model parameters. If the accuracy or level of performance does not meet a threshold or configured level, the AI engine 213 incrementally adjusts the model parameters until the machine learning model generates predictions at a desired or configured level of accuracy with respect to the annotated labels in the training data (e.g., the ground truth data). In other words, a “trained” machine learning model has model parameters adjusted to make accurate predictions (e.g., predictions of the value metric) with respect to the training data set. In the case of a neural network, the model paraments can include, but are not limited, to the coefficients or weights and biases assigned to each connection between neurons in the layers of the neural network (as further detailed in FIG. 14).

It is contemplated that the AI engine 213 can output such predictions to the questionnaire generation module 203 for generation of new questionnaires that will determine preference information with greater accuracy (e.g., high confidence levels).

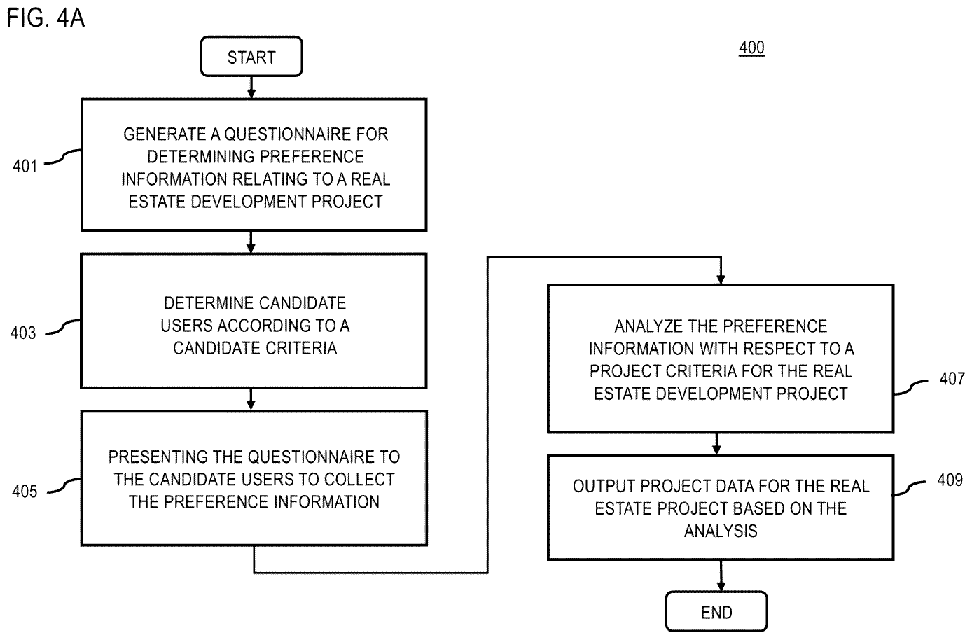

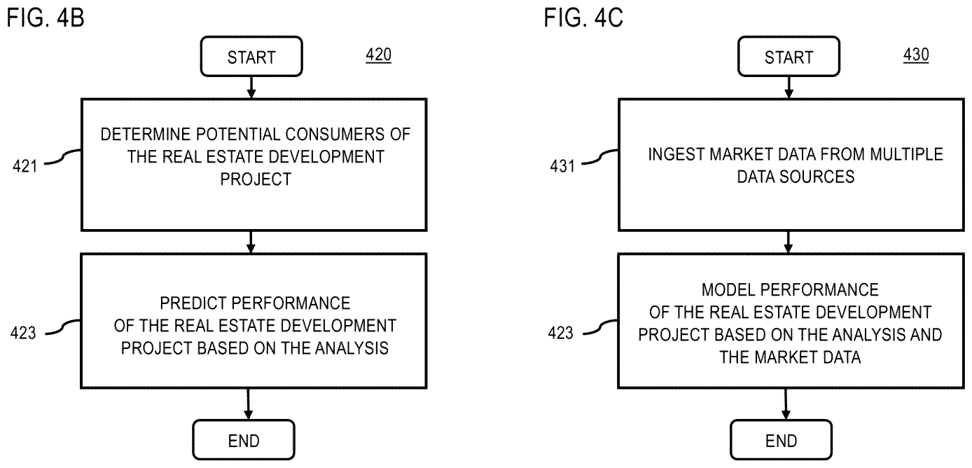

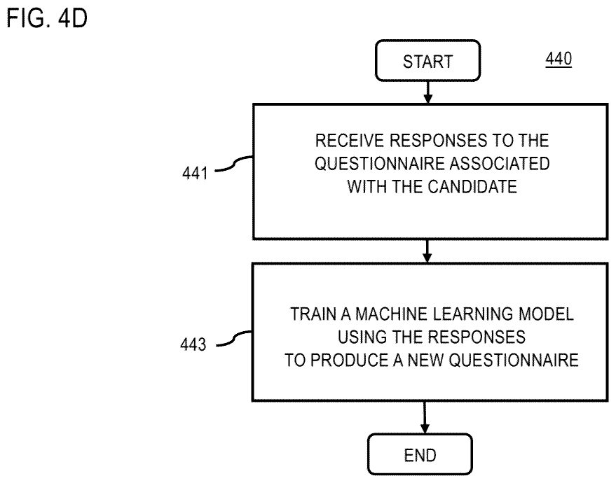

The above presented modules and components of the data mining platform 101 can be implemented in hardware, firmware, software, or a combination thereof. Though depicted as a separate entity in FIG. 1, it is contemplated that the data mining platform 101 may be implemented for direct operation by respective UE 105. As such, the data mining platform 101 may generate direct signal inputs by way of the operating system of the UE 105 for interacting with the applications 107. In another embodiment, one or more of the modules of FIG. 2 and processes of FIGS. 4A-4D may be implemented for operation by respective UEs, the data mining platform 101, or combination thereof. The various executions presented herein contemplate any and all arrangements and models—e.g., as implemented in FIG. 3.

FIG. 3 is a diagram of the data mining platform of FIG. 1 interacting with various data sources, according to one embodiment. By way of example, the data mining process relates to a multi-family scenario—i.e., specifically, feasibility. Functionally, system 300 can be implemented by the platform 101 to include the following data processing stages: data generated 301, data stored 303, data processed 305, and actionable intelligence 307. As shown, various types of data (originating from various data sources) can be ingested. The data can be unstructured, semi-structured, and/or structured, and can include any type of files (e.g., text, audio/visual, etc.). Upon the data being ingested with input from the users, such data is stored and analyzed using known and proprietary analytics and artificial intelligence algorithms. The platform 101 then produces models to provide descriptive, predictive, and prescriptive insights, resulting in reports and presentations via a graphical user interface (GUI), e.g., online data dashboard. The output information is considered actionable intelligence 307 for the user to optimize development efforts while mitigating risks.

According to one embodiment, a user (e.g., investors/financiers, developers, owners/operators, architects, agents, etc.) can specify certain query parameters to initiate the evaluation of a project: location (e.g., market and ZIP code), asset class, asset type (e.g., low-rise, mid-rise, high-rise), unit mix, rent rate, building amenities, unit features, resident services, and building design. The platform 101 can identify the audience and execute demand indexing and segmentation as to identify the prospective renter populations that are most likely to consider/choose the property (based on user inputs). The platform 101 can determine who the renters are, where they are, how many of them exist, what kind of residential product they live in, along with how much they are willing to pay as well as how much they actually pay. The platform 101 indexes the demand among the prospective renters according to “base” targets (i.e., those consumers who would most likely choose the property and “expansion” audiences (those who can be persuaded to consider the property)). The “base” and “expansion” audiences can be characterized based on information such as geo-demographic, psychographic, life-stage, and life style as well as their preferences.

With respect to asset development, the platform 101 determines what the target audiences are seeking in terms of an “ideal” apartment by defining certain attributes that such audience value most. For example, the platform 101 can isolate attributes of a premise (e.g., location, building, unit) that are valued by prospective renter populations, and prioritize the attributes. Based on such prioritization, the platform 101 can generate a unit/mix configuration and cost matrix (by prospect segment)—e.g., “user proposed” versus “market appetite.” Additionally, the platform 101 can produce programming evaluation/ROI matrices that capture the following information: building amenities, unit features/finishes, resident services, etc.; according to one embodiment, these matrices can be scored on “differentiation” (relevance/importance) versus “compelling” (preference/premiums).

Furthermore, the platform 101 is capable of performing a competitive landscape analysis. For instance, the platform 101 can generate area attribute scoring according to the following factors: retail/entertainment, walkability, schools, crime, etc. As part of this analysis, other information can be considered, such as location (whether favorable or unfavorable), and head-to-heads (in-market GEOs). Additionally, property rankings (e.g., by target audience demand drivers/preferences, etc.) can be considered in the analysis.

Demand mapping is supported by the platform 101, whereby the platform 101 generates a renter issue matrix to capture knowledge of the renters'preferences and dislikes; the platform 101 can utilize the matrix to determine malleability of the renters. The platform 101 can thus assess demand using a decision criteria associated with a particular target audience (which may be the “base” and/or “expansion” audience). A threshold (e.g., top 3) can be established to gauge the target audience's “must-haves” across amenity, feature, and service categories; “preference drivers” (impact) on consideration/lease likelihood; and “premium drivers” (impact) on rent thresholds. Asset performance baseline can be determined by the platform 101; such baseline can model performance in terms of demand, desirability, preference, and premiums.

The data mining process executed by the platform 101 results in information that mitigates investment/development risk. The platform 101 yields reports that can indicate what to build, for whom, where, and at what price point. In other words, the platform 101 deploys appropriate programming, placemaking and positioning based on what the target audience values most.

Although the above processes are described with respect to feasibility, the platform 101 can be configured to analyze the following scenarios: messaging and movers, resident experience, repositioning and Return on Investment (ROI) evaluation, live-space. Additionally, it is contemplated that the platform 101 can model commercial properties in addition to residential.

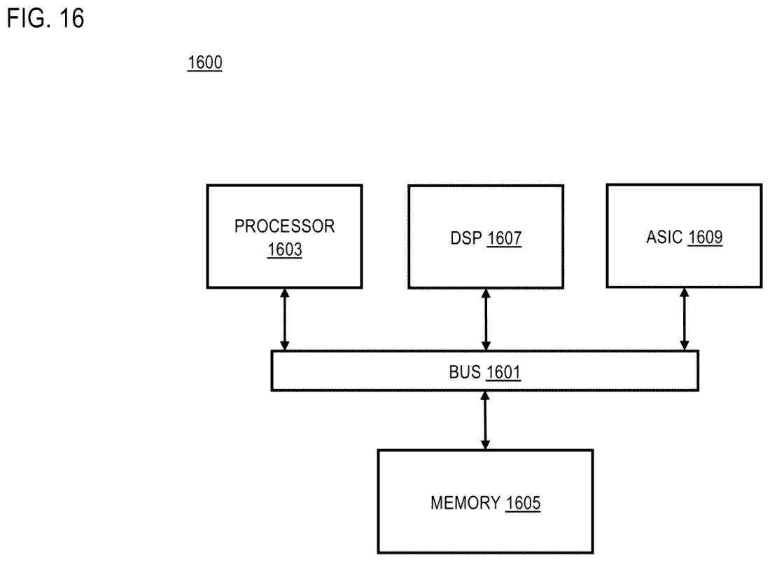

FIGS. 4A-4D are flowcharts of processes for maximizing real estate assets by the data mining platform of FIG. 1, according to various embodiments. The data mining platform 101 performs the processes 400, 420, 430, and 440 and is implemented in, for instance, a chip set including a processor and a memory as shown in FIG. 16. As shown in FIG. 4A, per step 401, a questionnaire is generated for determining preference information relating to a real estate development project. According to one embodiment, preference information relates to location, location attributes, building and unit attributes, building amenities, or a combination thereof. Also, the questionnaire can include questions pertaining to preferences, behavior, attitude, lifestyle interests, and lifestage. Candidate users are determined according to a candidate criteria, as in step 403. In one embodiment, the candidate criteria is based on geo-demographic information, and psychographic information. This permits the platform 101 to determine the high propensity target audience. That is, the platform 101 provides an understanding of who the target audiences really are and what's important to them (i.e., their decision-drivers). When paired with contextual market data, the platform 101 enables users to exploit the collective power of audience insights and, then, to focus on the underlying triggers of demand, advocacy, premiums and loyalty.

As in step 405, the questionnaire can be presented, via a graphical user interface (e.g., UE 105), to the candidate users to collect the preference information. Per step 407, the preference information is analyzed with respect to a project criteria for the real estate development project. The platform 101, under one scenario, combines expressed preferences of renter populations (both prospective and current), the unique characteristics of their environments and related behaviors to capture enhanced audience insight. The platform 101 stratifies existing and prospective renter populations by their typologies, and determines the motivational context behind their preferences, behaviors and decisions, and what wants/needs will drive future demand (in order to meet them where they are and move where they will be).

Project data for the real estate development project is output based on the analysis (step 409). According to various embodiments, the project date includes architectural information that permits the developers to design and manage the real estate assets (e.g., commercial buildings, facilities, residential homes, apartments, etc.).

FIG. 4B depicts a capability of the platform 101, whereby the platform 101 can execute process 420 to determine potential consumers of the real estate development project (step 421). Additionally, the platform 101 can predict performance of the real estate development project based on the analysis of process 400 (step 423).

To enhance the accuracy of its analysis, the platform 101, per process 430 (of FIG. 4C) can ingest data from a variety of data sources that would lend insight to determining the survey respondents to information about the location of the asset, etc. (step 431). Moreover, the platform 101 can model performance of the real estate development project based on the analysis and the market data, as in step 423.

As described, a vital aspect of the platform 101 is the ability to generate questionnaires to be meaningful towards a particular project analysis. In one embodiment, the platform 101 leverages machine learning to generate improved questionnaires by using the responses to the questionnaires to train the machine learning model of AI engine 213.

FIG. 5 is a diagram of a graphical user interface (GUI) presented by the data mining platform of FIG. 1 for developer scenario analysis, according to one embodiment. As shown, GUI 500 includes a Create a New Scenario Analysis section 501, a View Queries section 503, a View Scenario Feedback section 505, and a View Reports section 507. Upon triggering the Start Analysis button within section 501, the user can specify various parameters to initiate analysis of a particular asset. Section 503 provides a historical record of previous queries that have been established for particular development project scenarios. Section 507 enables collection of feedback relating to certain scenarios. Reports, via section 507, can be generated regarding various aspects of particular scenarios.

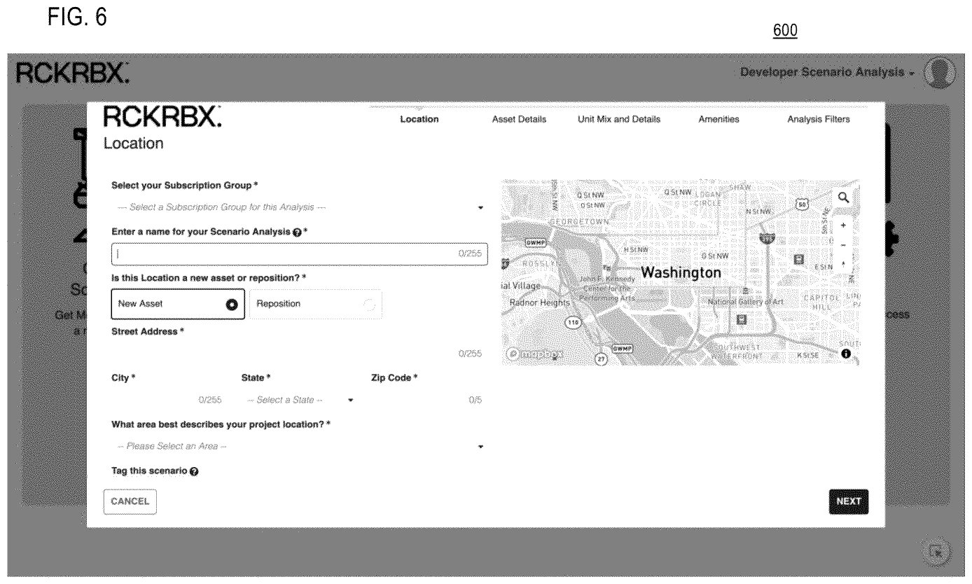

FIG. 6 is a diagram of a GUI presented by the data mining platform of FIG. 1 for specifying a developer scenario analysis, according to one embodiment. Under this example, GUI 600 provides fields to input information about a new scenario analysis for a desired location. Such fields include, but are not limited to, the following: title or name of the scenario analysis, type of location (whether it is a new asset or a reposition), address of the location, a description of the location. Optionally, GUI 600 permits the user to specify a particular subscription group (e.g., a pre-selected set of users) for the analysis.

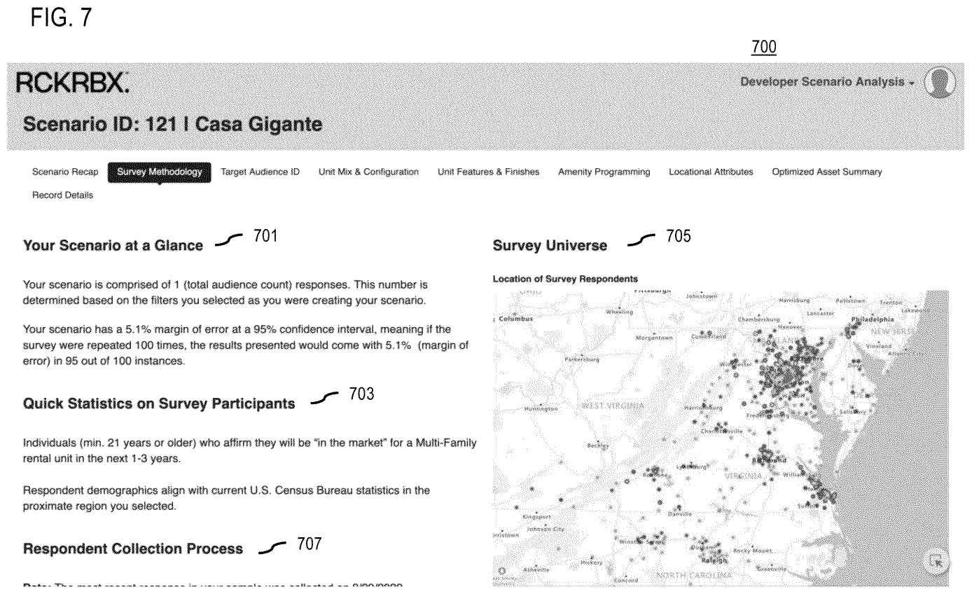

FIG. 7 is a diagram of a GUI presented by the data mining platform of FIG. 1 for displaying location of survey respondents, according to one embodiment. As explained, a key aspect of the platform 101 is the ability to generate meaningful surveys/questionnaires and to incorporate such information into the analysis. GUI 700 provides in section 701 a summary of a particular scenario that has been analyzed. Additionally, GUI 700 includes section 703 that provides statistical information on the survey participants, and section 705 that illustrates a map of where the survey respondents are located. GUI 700 can provide other information about the survey methodology such as section 707, which describes the respondent collection process.

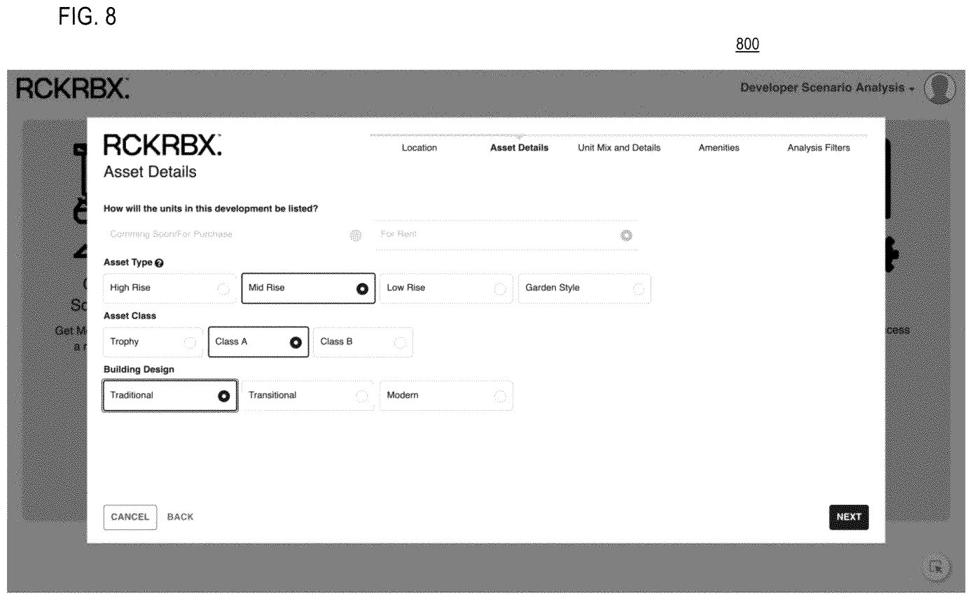

FIG. 8 is a diagram of a GUI presented by the data mining platform of FIG. 1 for specifying asset details relating to a developer scenario analysis, according to one embodiment. GUI 800 permits a user to specify, for instance, the manner in which the units in a development (i.e., asset) is to be listed—e.g., “Coming Soon/For Purchase” or “For Rent.” GUI 800 also allows other information about the asset to be specified: Asset Type (e.g., high rise, mid-rise, low rise, garden style, etc.), Asset Class (e.g., Trophy, Class A, Class B, etc.), and Building Design (e.g., Traditional, Transitional, Modern, etc.).

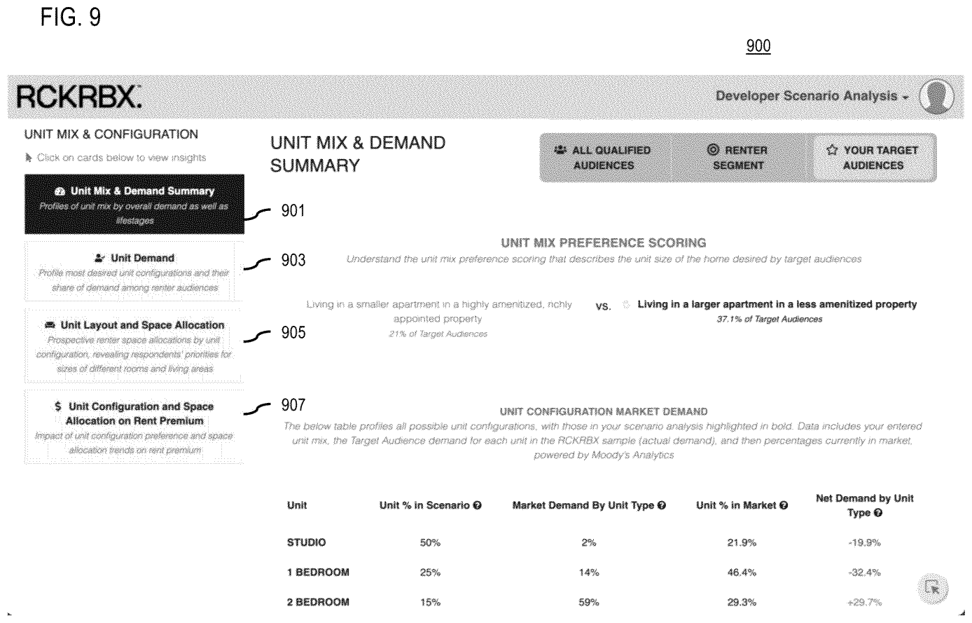

FIG. 9 is a diagram of a GUI presented by the data mining platform of FIG. 1 for providing a unit mix and demand summary associated with a developer scenario analysis, according to one embodiment. As part of its capability, the platform 101 outputs for a development, information about the unit mix and configuration. GUI 900 includes tab 901 for “Unit Mix & Demand Summary,” tab 903 for “Unit Demand,” tab 905 for “Unit Layout and Space Allocation,” and “Unit Configuration and Space Allocation on Rent Premium,” tab 907. As shown, tab 901 presents, e.g., a unit mix preference scoring (which describes the size of the unit preferred by the target audience) along with the unit mix configuration market demand.

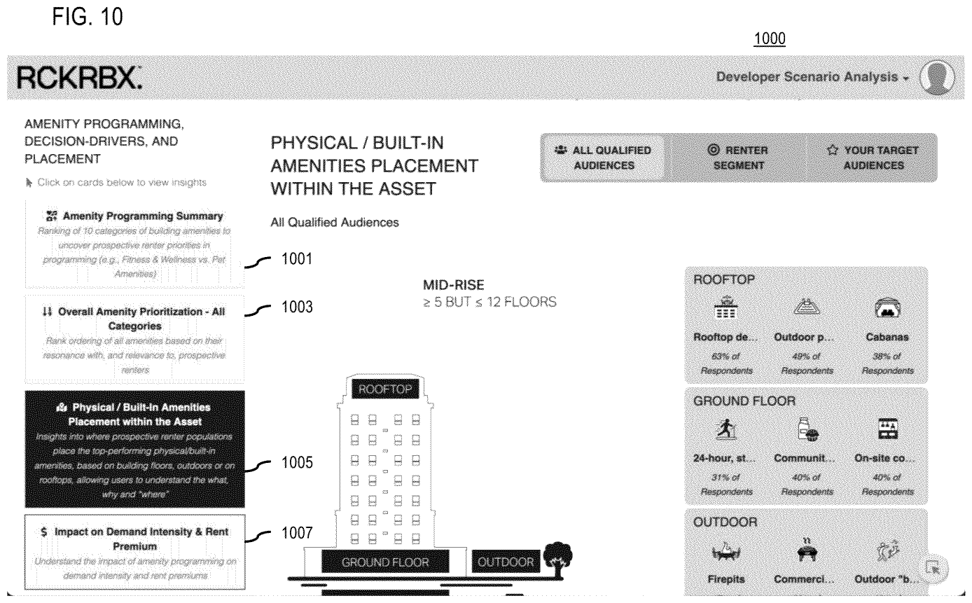

FIG. 10 is a diagram of a GUI presented by the data mining platform of FIG. 1 for providing information relating to physical/built-in amenities placement with an asset, according to one embodiment. GUI 1000 shows information relating to amenity programming, decision-drivers, and placement via the following tabs: tab 1001 (“Amenity Programming Summary”); tab 1003 (“Overall Amenity Prioritization—All Categories”); tab 1005 (“Physical/Built-In Amenities Placement within the Asset”); and tab 1007 (“Impact on Demand Intensity & Rent Premium”). In this example, tab 1005 is selected, and thus displays a representation of a mid-rise with its amenities associated with the building.

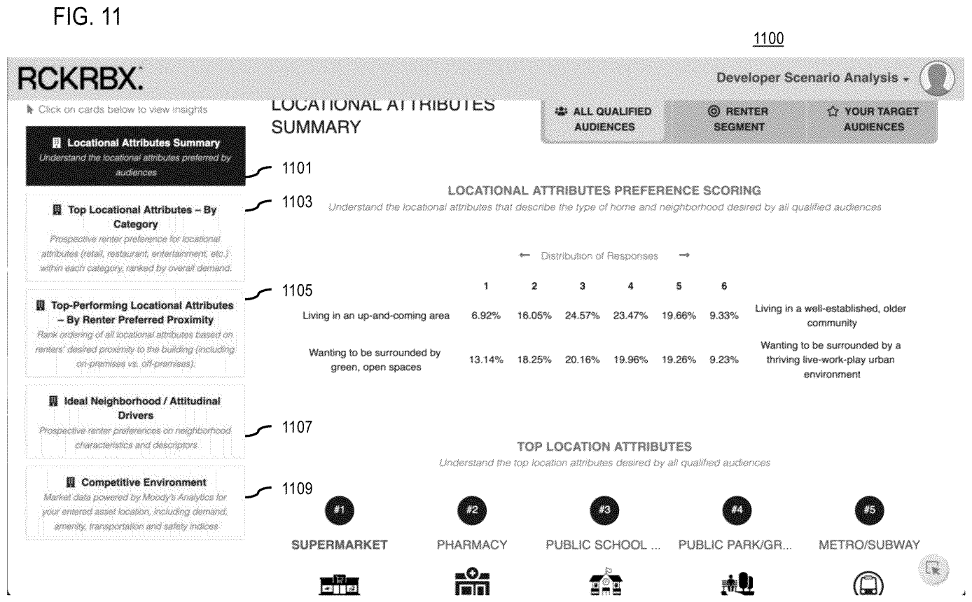

FIG. 11 is a diagram of a GUI presented by the data mining platform of FIG. 1 for providing information relating to locational attributes, according to one embodiment. GUI 1100 includes a variety of tabs relating to different aspects of the location of an asset: tab 1101 (“Locational Attributes Summary”); tab 1103 (“Top Locational Attributes—By Category”); tab 1105 (“Top Performing Locational Attributes - By Renter Preferred Proximity”); tab 1107 (“Ideal Neighborhood/Attitudinal Drivers”); and tab 1109 (“Competitive Environment”). In this example, Locational Attributes Summary tab 1101 presents Locational Attributes Preference Scoring associated with attributes that describe the type of home and neighborhood desired by all qualified audiences (as shown, the information can be tailored by a renter segment or target audiences). Tab 1101 shows a ranking (high to low) of location attributes—e.g., supermarket, pharmacy, public school, public parking/garage, and metro/subway.

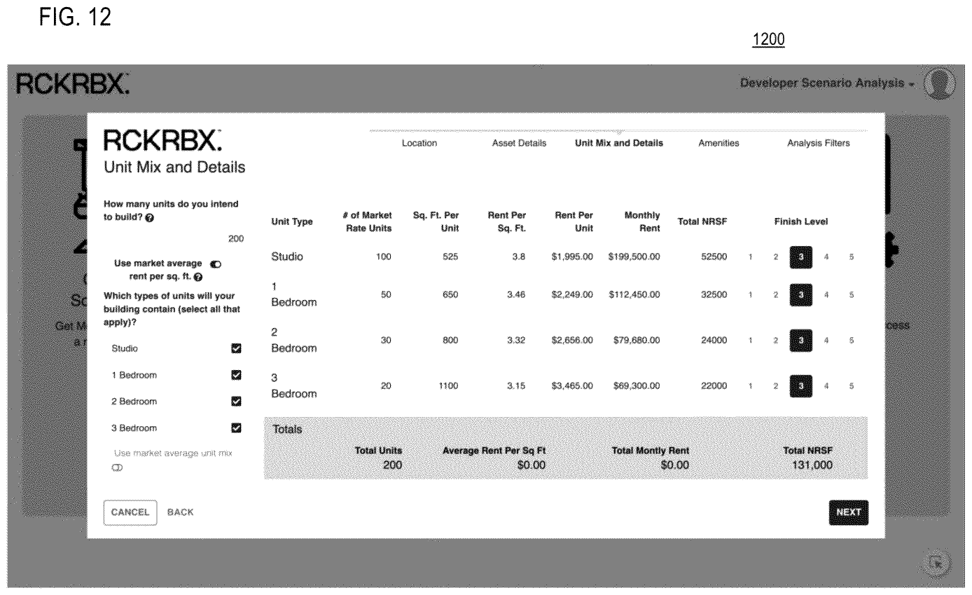

FIG. 12 is a diagram of a GUI presented by the data mining platform of FIG. 1 for specifying information relating to unit mix and details, according to one embodiment. GUI 1200 allows the user to specify the number of units for a development and the types of units: for example, studio, 1 bedroom, 2 bedroom, and 3 bedroom.

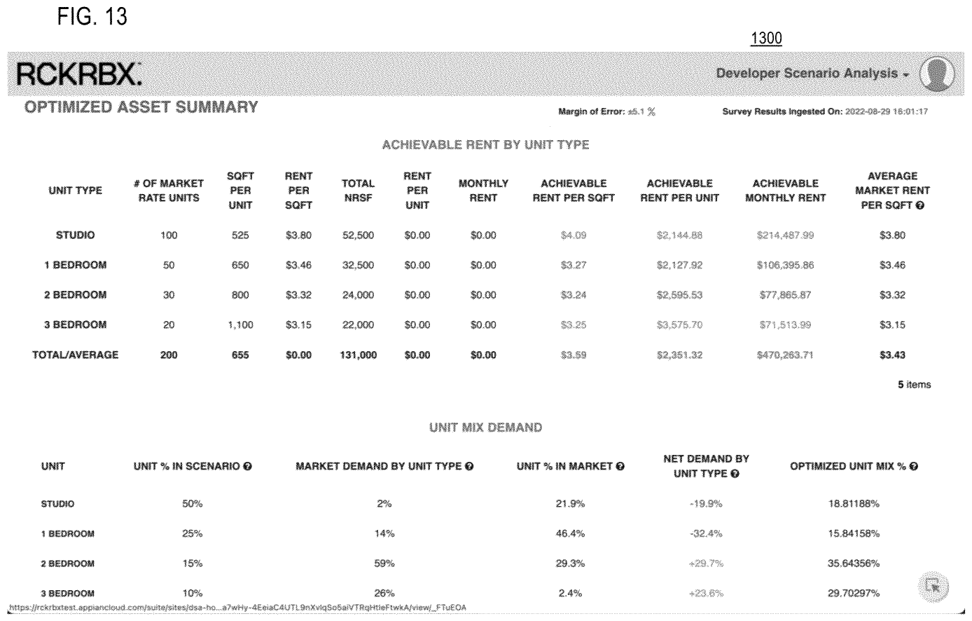

FIG. 13 is a diagram of a GUI presented by the data mining platform of FIG. 1 for providing information relating to an optimized asset, according to one embodiment. GUI 1300 captures the output of the scenario analysis by platform 101. By way of example, achievable rent information by unit type is presented and unit mix demand.

Consistent with the explanations provided in the above diagrams, users can leverage the data mining platform 101 across the commercial real estate ecosystem to better understand what renters want, think, see and feel in real-time, forecast how such audience decision-drivers will impact demand, lease likelihoods, pace and premiums of a potential project, and optimize their development-to-disposition path to deliver greater net operating income (NOI), enhance competitive performance, mitigate risk across the ownership lifecycle, and maximize liquidity and returns. It is noted that in addition to the value of the collected raw data value, the platform 101 has the capability to quickly extract insights, forecasts, patterns, etc. and use those predictions to (for instance): design new and more aligned market-entry and management strategies; test/refine underwriting assumptions to mitigate risk and optimize asset programming, performance and profitability; identify and prioritize target audiences, what matters most to them and what the developers should build for them to maximize demand, lease likelihood, pace and premiums; provide a holistic look at the way populations, assets and markets will perform over time and why; and more accurately predict opportunities with outsized potential for value appreciation. In effect, the platform 101 provides “actionable” decision intelligence for the real estate industry; it is contemplated that such intelligence can be generated for other industries as well, particularly those involving infrastructure planning.

FIG. 14 illustrates an example neural network 1401 (e.g., an example of the AI engine 213 implementing a machine learning model) that has an architecture including an input layer 1403 comprising one or more input neurons 1405, one or more hidden neuronal layers 1407 comprising one or more hidden neurons 1409, and an output layer 1411 comprising one or more output neurons. In one embodiment, the architecture of the neural network 1401 refers to the number of input neurons 1405, the number of neuronal layers 1407, the number of hidden neurons 1409 in the neuronal layers 1407, the number of output neurons, or a combination thereof. In addition, the architecture can refer to the activation function used by the neurons, the loss functions applied to train the neural network 1401, parameters indicating whether the layers are fully connected (e.g., all neurons of one layer are connected to all neurons of another layer) or partially connected, and/or other equivalent characteristics, parameters, or properties of the neurons 1405/1409/1413, neuronal layers 1407, or neural network 1401. Although the various embodiments described herein are discussed with respect to a neural network 1401, it is contemplated that the various embodiments described herein are applicable to any type of machine learning model (not shown) that can be migrated between different architectures.

In one embodiment, the progressive path migrates an old architecture of a machine learning model into a new architecture by incrementally adding and removing single neurons or neuronal layers, or smoothly changing activation functions in a fashion which does not affect performance of the machine learning model by more than a designated performance change threshold. For example, a user may wish to migrate a machine learning model from an architecture that has three hidden neuronal layers 1407 with four hidden neurons 1409 in each layer to a new architecture that has four hidden neuronal layers 1407 with four hidden neurons 1409 each. The machine learning model has been trained using the old architecture for a significant period of time. To advantageously preserve the training already performed and maintain model performance at a target level, the AI engine 213 can construct a progressive path with four steps that incremental adds one hidden neuron 1409 to the new neuronal layer 1407 at each step until the full new neuronal layer 1407 is added. In other words, while the machine learning model is being trained, a new technical solution or architecture may be discovered that can provide improvements to the machine learning model (not shown). Then instead of replacing the old system architecture in a cut-off fashion, the AI engine 213 can construct incremental steps that can be used to progressively migrate the existing trained machine learning model to avoid catastrophic degradation of the trained machine learning model's performance.

As noted, the machine learning model can be trained using responses (e.g., preference information) from the questionnaires to fine tune the accuracy of performance modeling and forecasting of profitable or successful real estate development projects. Such machine learning model can then generate more precise questions as to eliminate ambiguity in the questions to yield more accurate preference information.

In one embodiment, while the progressive migration is being done, the training process continues. In this way, the newly added neurons learn relatively quickly their new roles in the machine learning model as their context environment consists of neuronal layers 1407 which already know their jobs (e.g., neuronal layers 1407 with neurons 1409 that have undergone at least some training). After migration the resulting machine learning model has incorporated expert knowledge from the old architecture, but has a new architecture, new technologies incorporated, and/or the like which can potentially improve the performance and learning of the machine learning model in the future. Accordingly, the embodiments of the system 101 described herein provide technical advantages including, but not limited to, providing long-lived machine learning systems that can be trained better while incorporating new advances in machine learning technologies (e.g., neural network technologies).

The processes described herein for providing data mining and analysis may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

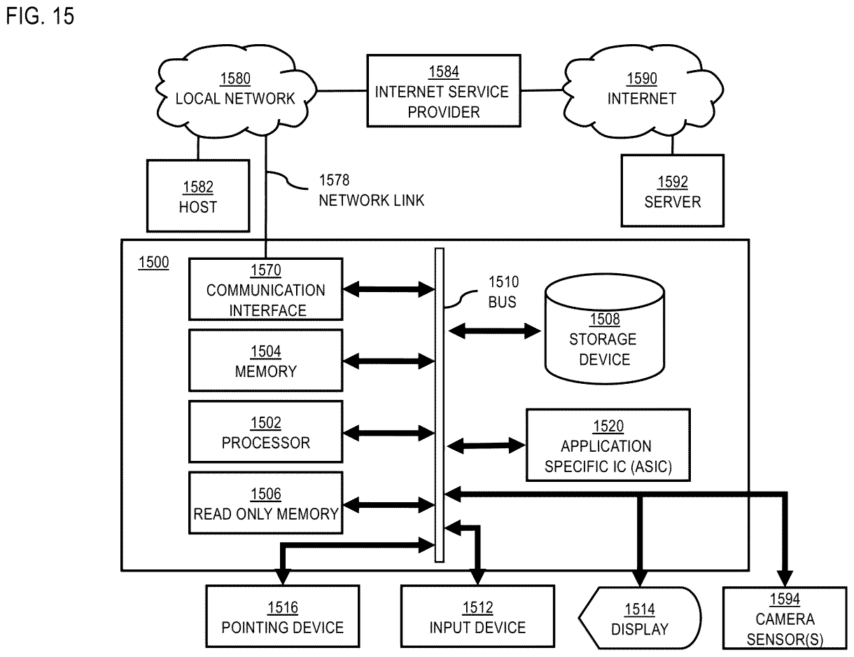

FIG. 15 illustrates a computer system 1500 upon which various embodiments of the invention may be implemented. Although computer system 1500 is depicted with respect to a particular device or equipment, it is contemplated that other devices or equipment (e.g., network elements, servers, etc.) within FIG. 15 can deploy the illustrated hardware and components of system 1500. Computer system 1500 is programmed (e.g., via computer program code or instructions) to data mining and analysis as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of the processes described herein, including that of FIG. 3.

A bus 1510 includes one or more parallel conductors of information so that information is transferred quickly among devices coupled to the bus 1510. One or more processors 1502 for processing information are coupled with the bus 1510.

A processor (or multiple processors) 1502 performs a set of operations on information as specified by computer program code related to data mining and analysis. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1500 also includes a memory 1504 coupled to bus 1510. The memory 1504, such as a random access memory (RAM) or any other dynamic storage device, stores information including processor instructions for providing real-time data analysis to support decision making. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or any other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for providing real-time data analysis to support decision making, at least in part, on analysis of collected information, is provided to the bus 1510 for use by the processor from an external input device 1512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 1516, such as a mouse, a trackball, cursor direction keys, or a motion sensor, for controlling a position of a small cursor image presented on the display 1514 and issuing commands associated with graphical elements presented on the display 1514, and one or more camera sensors 1594 for capturing, recording and causing to store one or more still and/or moving images (e.g., videos, movies, etc.) which also may comprise audio recordings. In some embodiments, for example, in embodiments in which the computer system 1500 performs all functions automatically without human input, one or more of external input device 1512, a display device 1514 and pointing device 1516 may be omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of ASICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners, and external disks. In general, the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 157 in support of the data mining platform 161.

The term “computer-readable medium” as used herein refers to any medium that participates in providing information to processor 1502, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 1508. Volatile media include, for example, dynamic memory 1504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1520.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system 1500 can be deployed in various configurations within other computer systems, e.g., host 1582 and server 1592.

At least some embodiments of the invention are related to the use of computer system 1500 for implementing some or all of the techniques described herein. According to one embodiment of the invention, those techniques are performed by computer system 1500 in response to processor 1502 executing one or more sequences of one or more processor instructions contained in memory 1504. Such instructions, also called computer instructions, software and program code, may be read into memory 1504 from another computer-readable medium such as storage device 1508 or network link 1578. Execution of the sequences of instructions contained in memory 1504 causes processor 1502 to perform one or more of the method steps described herein. In alternative embodiments, hardware, such as ASIC 1520, may be used in place of or in combination with software to implement the invention. Thus, embodiments of the invention are not limited to any specific combination of hardware and software, unless otherwise explicitly stated herein.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server host 1592 transmits program code for a particular application, requested by a message sent from computer 1500, through Internet 1590, ISP equipment 1584, local network 1580 and communications interface 1570. The received code may be executed by processor 1502 as it is received, or may be stored in memory 1504 or in storage device 1508 or any other non-volatile storage for later execution, or both. In this manner, computer system 1500 may obtain application program code in the form of signals on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set or chip 1600 upon which various embodiments of the invention may be implemented. Chip set 1600 is programmed to the processes (e.g., FIG. 3) as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1600 can be implemented in a single chip. It is further contemplated that in certain embodiments the chip set or chip 1600 can be implemented as a single “system on a chip.” It is further contemplated that in certain embodiments a separate ASIC would not be used, for example, and that all relevant functions as disclosed herein would be performed by a processor or processors. Chip set or chip 1600, or a portion thereof, constitutes a means for performing one or more steps of providing user interface navigation information associated with the availability of functions. Chip set or chip 1600, or a portion thereof, constitutes a means for performing one or more steps of providing data mining and analysis.

In one embodiment, the chip set or chip 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1600 includes merely one or more processors and some software and/or firmware supporting and/or relating to and/or for the one or more processors.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to provide data mining and analysis. The memory 1605 also stores the data associated with or generated by the execution of the inventive steps.

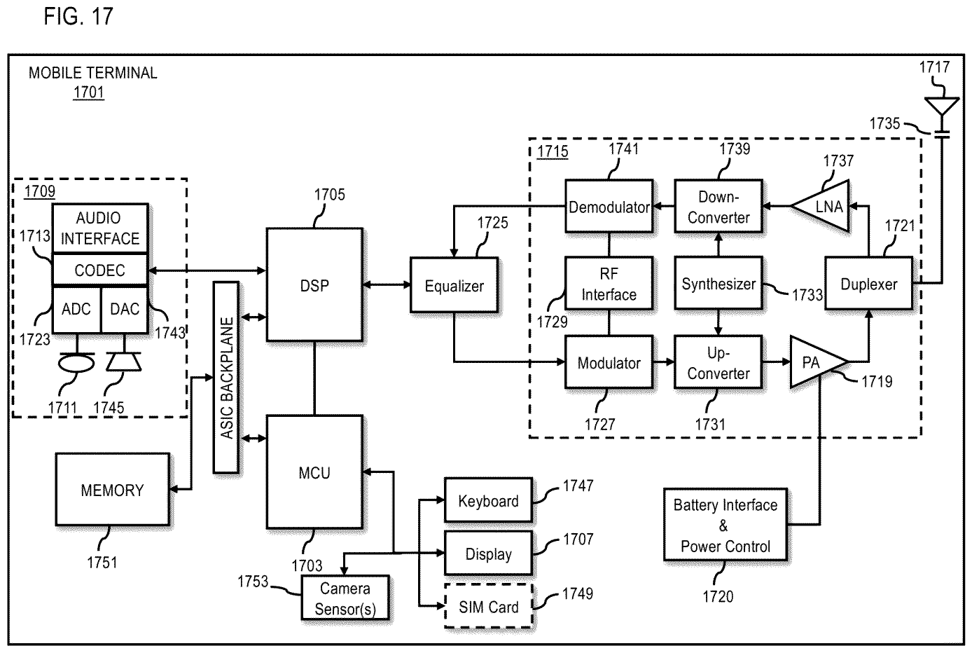

FIG. 17 is a diagram of exemplary components of a mobile terminal (e.g., handset) for communications, which is capable of operating in the system of FIG. 1, according to one embodiment. In some embodiments, mobile terminal 1701, or a portion thereof, constitutes a means for performing one or more steps of the described processes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps of data mining and analysis. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies the power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1725 for compensation of any frequency-dependent impairments that occur during transmission though the air such as phase and amplitude distortion. After equalizing the bit stream, the modulator 1727 combines the signal with an RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703 which can be implemented as a Central Processing Unit (CPU).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 to provide data mining and analysis. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

Further, one or more camera sensors 1753 may be incorporated onto the mobile station 1701 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
generating a questionnaire for determining preference information relating to a real estate development project;
determining a plurality of candidate users according to a candidate criteria;
presenting, via a graphical user interface, the questionnaire to the plurality of candidate users to collect the preference information;
analyzing the preference information with respect to a project criteria for the real estate development project; and
outputting project data for the real estate development project based on the analysis, wherein the project date includes architectural information.

2. The method of claim 1, further comprising:
determining potential consumers of the real estate development project based on the analysis.

3. The method of claim 1, further comprising:
predicting performance of the real estate development project based on the analysis.

4. The method of claim 1, wherein the preference information relates to location, location attributes, building and unit attributes, building amenities, or a combination thereof.

5. The method of claim 1, wherein the questionnaire includes questions pertaining to preferences, behavior, attitude, lifestyle interests, and lifestage, the method further comprising:
receiving responses to the questionnaire associated with the plurality of candidate users; and
training a machine learning model using the responses to produce a new questionnaire.

6. The method of claim 1, further comprising:
ingesting market data from a plurality of data sources; and
modeling performance of the real estate development project based on the analysis and the market data.

7. The method of claim 1, wherein the candidate criteria is based on geo-demographic information, and psychographic information.

8. A system comprising:
a memory configured to store computer-executable instructions; and
one or more processors configured to execute the instructions to:
generate a questionnaire for determining preference information relating to a real estate development project;
determine a plurality of candidate users according to a candidate criteria;
present, via a graphical user interface, the questionnaire to the plurality of candidate users to collect the preference information;
analyze the preference information with respect to a project criteria for the real estate development project; and
output project data for the real estate development project based on the analysis, wherein the project date includes architectural information.

9. The system of claim 8, wherein the one or more processors are further configured to execute the instructions to:
determine potential consumers of the real estate development project based on the analysis.

10. The system of claim 8, wherein the one or more processors are further configured to execute the instructions to:
predict performance of the real estate development project based on the analysis.

11. The system of claim 9, wherein the preference information relates to location, location attributes, building and unit attributes, building amenities, or a combination thereof.

12. The system of claim 9, wherein the questionnaire includes questions pertaining to preferences, behavior, attitude, lifestyle interests, and lifestage, wherein the one or more processors are further configured to execute the instructions to:
receive responses to the questionnaire associated with the plurality of candidate users; and
train a machine learning model using the responses to produce a new questionnaire.

13. The system of claim 8, wherein the one or more processors are further configured to execute the instructions to:
ingest market data from a plurality of data sources; and
model performance of the real estate development project based on the analysis and the market data.

14. The system of claim 11, wherein the candidate criteria is based on geo-demographic information, and psychographic information.

15. An apparatus comprising:
at least one processor; and
at least one memory including computer program code for one or more programs,
the at least one memory and the computer program code configured to, with the at least one processor, cause the apparatus to perform at least the following,
generate a questionnaire for determining preference information relating to a real estate development project;
determine a plurality of candidate users according to a candidate criteria;
present, via a graphical user interface, the questionnaire to the plurality of candidate users to collect the preference information;
analyze the preference information with respect to a project criteria for the real estate development project; and
output project data for the real estate development project based on the analysis, wherein the project date includes architectural information.

16. The apparatus of claim 15, wherein the apparatus is further caused to:
determine potential consumers of the real estate development project based on the analysis.

17. The apparatus of claim 15, wherein the apparatus is further caused to:
predict performance of the real estate development project based on the analysis.

18. The apparatus of claim 16, wherein the preference information relates to location, location attributes, building and unit attributes, building amenities, or a combination thereof, wherein the questionnaire includes questions pertaining to preferences, behavior, attitude, lifestyle interests, and lifestage, wherein the apparatus is further caused to:
receive responses to the questionnaire associated with the plurality of candidate users; and
train a machine learning model using the responses to produce a new questionnaire.

19. The apparatus of claim 15, wherein the apparatus is further caused to:
ingest market data from a plurality of data sources; and
model performance of the real estate development project based on the analysis and the market data.

20. The apparatus of claim 18, wherein the candidate criteria is based on geo-demographic information, and psychographic information.
